(19) United States
(12) Patent Application Publication
(10) Pub. No.: US 2015/0368953 A1
(43) Pub. Date: Dec. 24, 2015

(54) GUIDANCE SYSTEM FOR SLIDING DOORS

(71) Applicant: GEBR. WILLACH GMBH, Ruppichteroth (DE)

(72) Inventors: Jens WILLACH, Eitorf (DE); Stefan SCHMITZ, Neunkirchen-Seelscheid (DE)

(73) Assignee: GEBR. WILLACH GMBH, Ruppichteroth (DE)

(21) Appl. No.: 14/410,957

(22) PCT Filed: Jun. 18, 2013
(86) PCT No.: PCT/EP2013/062624

§ 371 Date: Dec. 23, 2014

(30) Foreign Application Priority Data
Jun. 27, 2012 (DE) 10 2012 211 018.6

(51) Int. Cl. E05F 15/60; E06B 3/46

(52) U.S. Cl. CPC E05F 15/60; E06B 3/4636; E05Y 2201/434; E05Y 2201/688; E05Y 2900/10

(57) ABSTRACT

A guidance system for sliding doors, with a running rail for guiding a track roller of a door guide, a drive system having a drive device, and a travel space of the door guide extending in the longitudinal direction of the running rail. The travel space is delimited at least in part by the running rail. The drive device is arranged in the longitudinal direction of the running rail as a prolongation of the travel space and is mounted via a mounting device in the running rail.

The present invention relates to a guidance system for sliding doors.

For the guidance of sliding doors, in particular glass sliding doors, guidance systems exist that have a running rail for guiding a track roller of a door guide, the running rail having a guide track for the track roller.

Further, guidance systems exist wherein the sliding door is driven by means of a drive system. Known drive systems comprise a belt drive, for example, which drives the door wings, a motor of the belt drive being arranged in the region of a support profile formed by two running rails with a guide track. Such a guidance system is known, for example, from DE 198 42 567 A1. In the known guidance system, a cavity is formed in the support profile, which cavity is located above the cavity in which a door slide mechanism of a door wing moves. The motor of the drive system is arranged in the upper cavity.

The known system has a rather complicated structure, since the support profile consists of two running rails and a stiffening profile, as well as a number of other parts. Further, the support profile of the known guidance system has rather large dimensions in order to provide sufficient space for receiving the door slide mechanism and for receiving the cavity above the door slide mechanism, which cavity receives the motor.

Further, the known guidance system provides no possibility to control the motor from outside, when it is installed.

It is therefore an object of the present invention to provide a guidance system for sliding doors that has a simple and compact structure. In this context, it shall be possible to control the drive system in a simple manner.

The invention is defined by the features of claim 1.

In the guidance system for sliding doors, preferably glass sliding doors, according to the present invention, with a running rail for guiding a track roller of a door guide and with a drive system having a drive device, preferably an electric motor, and a travel space of the door guide extending in the longitudinal direction of the running rail, which travel space is delimited at least in part by the running rail, e.g. laterally, i.e. in a direction orthogonal to the longitudinal direction, it is provided that the drive device is arranged in the longitudinal direction of the running rail as a prolongation of the travel space and is mounted via a mounting device in the running rail.

The travel space of the door guide is the space extending in the longitudinal direction of the travel path of the door guide, which space the door guide moves through as it travels.

Thus, the guidance system of the present invention can be of a very compact design, since the drive device is arranged in a space that, in the longitudinal direction of the running rail, directly or indirectly adjoins the space in which the door guide travels. Thereby, the running rail of the guidance system of the present invention can be designed with a relatively low height. In particular, the drive device is arranged completely in the region of the running rail and does not protrude beyond the running rail in the longitudinal direction.

The guidance system of the present invention may provide that the running rail comprises a guide track for the track roller of the door guide, the mounting device of the drive device engaging the guide track of the running rail.

The guidance system of the present invention may have a very simple structure, since the drive device is fastened in the guide track of the running rail and thus uses means of the running rail already existing in the running rail for the door guide. Since the guide track of a running rail is well accessible during assembly in order to mount the sliding door via the door guide, it is also possible to mount the drive device in the running rail in a simple manner.

Due to the fact that the drive device is mounted in the guide track of the running rail, it is possible to advantageously retrofit already existing systems with a drive system, for example. Most often, the already mounted running rail can even remain in place and it is merely necessary to insert and fasten the drive device in the running rail.

According to the invention it may be provided that the running rail has a wall opposite the guide track, the mounting device engaging between the wall and the guide track in a clamping manner. Such a structure is advantageous in that the mounting device is not only simple to mount in the running rail, but the clamping engagement also allows for a simple displacement of the mounting device, and thus of the drive device, in the longitudinal direction of the rail by loosening the mounting device. Thereby, the drive device can advantageously be fastened at a desired position during the assembly of the guidance system of the present invention.

It may be provided that a cover is fastened on the running rail, with a cavity being formed between the cover and the running rail, the drive system being arranged in the cavity. Here, the travel space of the door guide is located in the cavity. Using the cover, it is possible to advantageously hide the drive device and the entire drive system from an observer, whereby the guidance system of the present invention is given an esthetically appealing exterior. The cavity formed between the cover and the running rail offers sufficient space to receive the drive device and the entire drive system which may comprises a belt drive, for example. Thus, the entire drive system is covered and is protected against external influences. The drive device, preferably the drive system, can thus be optically covered by the cover in a direction orthogonal to the major surface of the cover.

In a particularly preferred embodiment of the invention it is provided that the drive system has a belt drive for driving a sliding door. Thereby, the sliding door can be driven in a particularly advantageous manner. For example, the belt drive can be arranged in the space formed by the running rail in which the drive device is arranged, whereby the belt drive can also be mounted and accessed in a simple manner, thus facilitating maintenance work. Moreover, other parts of the drive system, such as a guide roller of the belt drive, for example, may also be mounted engaging into the guide track of the running rail.

In a preferred embodiment of the invention which, however, is of independent importance, a cover or the cover is fastened to the running rail, a passage for the sliding door being formed between the cover and the running rail, with an operating panel for the drive system being arranged at or in the passage. In other words: the operating panel is arranged in the gap formed between the running rail and the cover, or above the gap formed between the running rail and the cover, whereby the operating panel is accessible in an advantageous manner and, above that, a visually appealing combination of the running rail, the cover and the operating panel can be provided.

In this regard, it may be provided in particular that the operating panel can be operated from the bottom side of the running rail. In this manner, the drive system can be controlled from outside by accessing the operating panel from the bottom side of the running rail that is usually freely accessible.

It may be provided that the operating panel fits flush with the running rail and/or the cover, whereby a visually appealing, largely continuous surface is formed between the operating panel and one or both adjoining parts of the guidance system.

In an embodiment of the invention it may be provided that the running rail comprises a first groove and the cover comprises a second groove, the second groove being arranged opposite the first groove, and the operating panel engages into the first and the second groove. In this manner, the operating panel can be fastened to the running rail and the cover in a particularly advantageous manner, wherein, due to the provision of the grooves, the operating panel can be displaced in an advantageous manner along the longitudinal direction of the running rail during the positioning of the panel. The first and the second groove extend in the longitudinal direction of the running rail and the cover, which allows for a simple manufacture thereof by extrusion.

In a preferred embodiment it is provided that the first groove is formed in a first front face of the of the running rail and the second groove is formed in a second front face of the cover, the first and second front faces delimiting the passage for the sliding door. Thus, the operating panel can be arranged in the passage in an advantageous manner, wherein the first and the second groove are at the same time suited to receive a brush seal, for example. The brush seals may, for instance, be arranged adjoining an operating panel provided in the passage, so that the cavity formed between the running rail and the cover is protected from environmental influences traversing the passage, such as dust, for example.

In one embodiment of the invention it is provided that the first front face adjoins the guide track. Thereby, the running rail and thus the entire guidance system can be designed in a very compact manner.

The following is a detailed description of the invention with reference to the accompanying Figures. In the Figures:

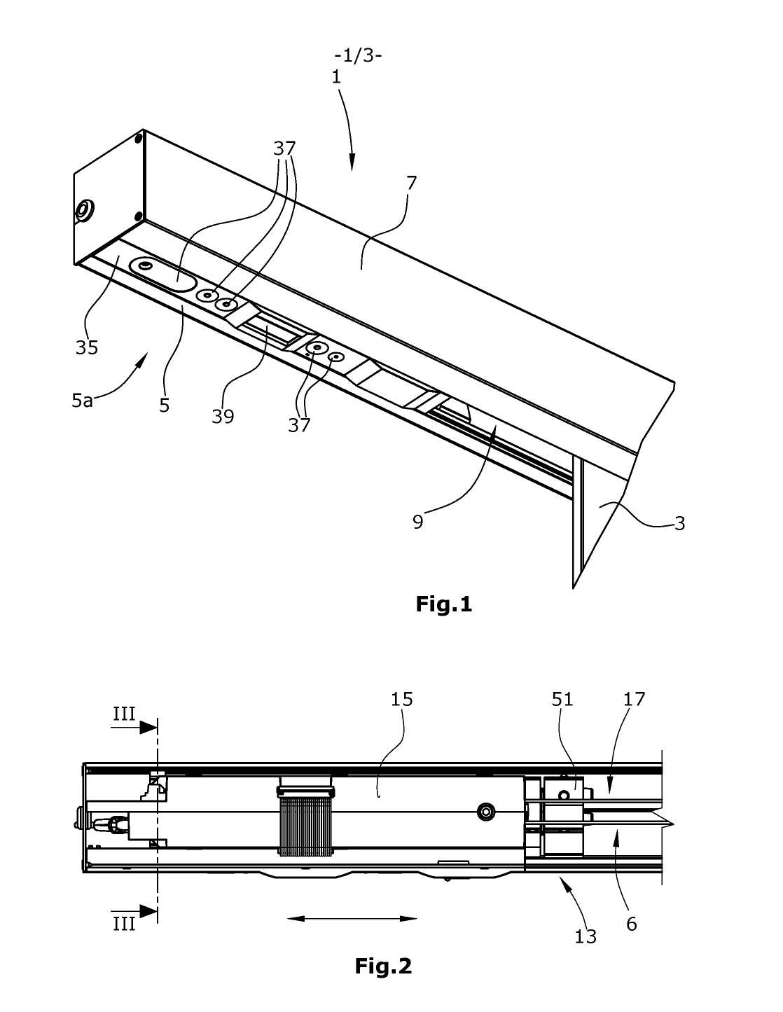

FIG. 1 is a schematic perspective illustration of the guidance system of the present invention,

FIG. 2 is a schematic side elevational view of the guidance system of the present invention without the cover,

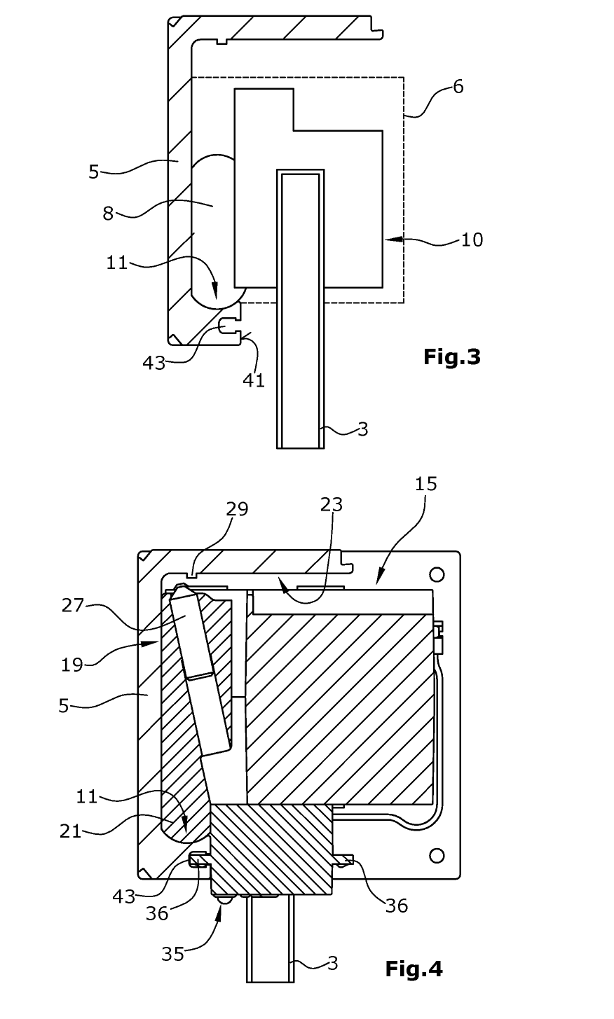

FIG. 3 is a schematic sectional view of the running rail of the guidance system of the present invention,

FIG. 4 is a schematic sectional view along the section III-III in FIG. 2, and

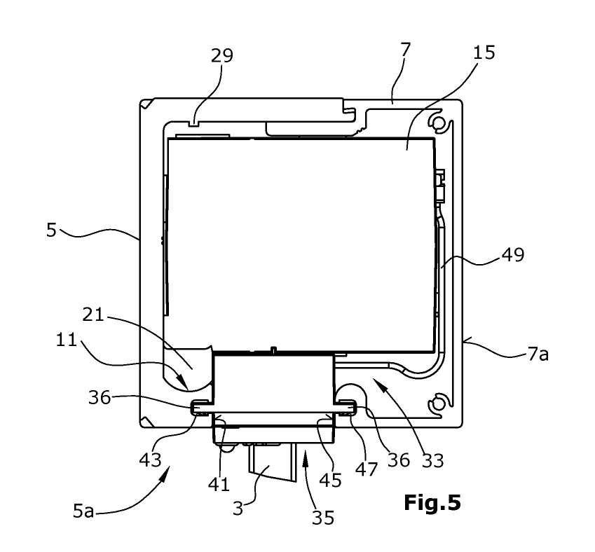

FIG. 5 is a schematic sectional view of the guidance system of the present invention with the cover.

In the Figures, the guidance system 1 for sliding doors 3 of the present invention is schematically illustrated with and without a cover.

The guidance system 1 illustrated is formed by a running rail 5 and a cover 7 covering the running rail. A passage 9 is formed between the running rail 5 and the cover 7, through which the sliding door 3 passes.

The running rail 5 serves to guide a track roller 8 of a door guide 10, for example a sliding door mechanism arranged on the door wing of the sliding door 3. The door guide 10 is illustrated in FIG. 3.

As best seen in FIGS. 3 and 4, the running rail 5 has a guide track 11 for the track roller 8 of the door guide 10.

The door guide 10 can be moved in the longitudinal direction of the running rail 5, the track roller 8 rolling on the guide track 11. The longitudinal direction of the running rail 5 is illustrated by an arrow in FIG. 2. The guidance system 1 of the present invention forms a travel space 6 extending along the travel path of the door guide 10 and thus in the longitudinal direction of the running rail 5. The travel space 6 is the space in which the door guide 10 is located during its travel. The travel space 6 is delimited at least in part by the running rail 5.

Further, a drive system 13 for the sliding door 3 is arranged in the running rail 5, the drive system 13 comprising a drive device 15, e.g. an electric motor, and a belt drive 17 driven thereby. The belt drive 17 may, for example, be connected with the door guide 10 to drive the sliding door 3.

The drive device 15 comprises a mounting device 19 by which the drive device 15 is fastened in the running rail 5. The drive device 15 is arranged in the longitudinal direction of the running rail 5 in prolongation of the travel space 6, with a stop 51 for the door guide 10 being arranged between the drive device 15 and the travel space 6. The stop may also be a part of the drive device 15 so that the same will then directly adjoin the travel space 6. For the purpose of fastening the drive device 15, the mounting device 19 engages into the guide track 11. In this regard, the mounting device 19 comprises a keystone 21 adapted to the contour of the guide track 11. The running rail 5 further comprises a wall 23 opposite the guide track 11, the mounting device 19 clampingly engaging between the wall 23 and the guide track 11. For this purpose, the mounting device 19 has a screw 27 pressing against the wall 23. To prevent the drive device from tipping out of the running rail 5, the wall 23 may further comprise a rib 29 extending in the longitudinal direction of the running rail 5, the rib cooperating with the screw 27. As an alternative, the mounting device may comprise a clamping block, e.g. a sliding block, pressed against the wall 23 by means of the screw 27. A groove arranged in the clamping block can then engage around the rib 29.

The cover 7 is fastened to the running rail 5 such that a cavity 33 is formed between the cover 7 and the running rail 5. The entire drive system 13 is arranged in the cavity 33 and is completely concealed to the observer by the cover 7, when seen in lateral plan view on the major surface 7a of the cover 7.

In the passage 9 formed between the cover 7 and the running rail 5, an operating panel 35 is arranged that can be operated from a bottom face 5a of the running rail 5. In other words: the operating panel 35 has various operating buttons 37 and a display 39, for instance, that are accessible to a user located below the running rail 5. In this manner, the drive system 13 arranged in the running rail 5 can be operated in a particularly simple manner. For example, the drive system 13 can be switched off or the drive system 13 can be reprogrammed, without the drive system 13 having to be immediately accessible.

As is best seen in FIG. 1, the operating panel 35 fits flush with the running rail 5 and the cover 7, with only a few of the operating elements projecting beyond the plane formed by the bottom face of the cover 7 and the running rail 5. Thus, the guidance system 1 of the present invention is of a visually appealing design.

For the purpose of fastening the operating panel 35 to the running rail 5 and the cover 7, the running rail 5 has a first front face 41 in which a first groove 41 is formed. The front face 41 adjoins the guide track 11. The cover 7 further comprises a second front face 45 in which a second groove 47 is formed. With the cover 7 mounted to the running rail 5, the second front face 45 and thus the second groove 47 faces the first front face 41 and thus the first groove 43. The passage 9 is formed between the first front face 41 and the second front face 45. The operating panel 35 engages the first groove 43 and the second groove 47 with tongues 36 and is thereby fastened to the running rail 5 and the cover 7.

The first and second grooves 43, 47 may also serve to receive brush seals, for example, which can be arranged adjacent the mounted operating panel 35 and prevent environmental influences, such as dust, for example, from entering the cavity 33 formed between the cover 7 and the running rail 5. Thereby, the drive system 13 is protected against environmental influences.

Both the drive system 13 and the operating panel 35 can be fastened in the running rail or the running rail 5 and the cover 7 in a very simple manner.

For example, the running rail 5 can be fastened at the mounting site first, before the drive system 13, in particular the drive device 15, is inserted into the guide track 11 and fastened therein. Thereafter, the operating panel 35 can be inserted into the first groove 43. The drive device 15 and the operating panel 35 can be connected via a data link 49. Then, the cover 7 is fastened to the running rail 5, with the operating panel 35 engaging the second groove 47. Owing to the structure of the guidance system 1 of the present invention, the drive system 13 can be fastened to the running rail 5 in a simple manner and can also be maintained in a simple manner, since it is only necessary to remove the cover 7 from the running rail 5 to be able to access all parts of the drive system 13.

In a manner similar to the drive device 15, other parts of the drive system 13 or the guidance system 1 can be fastened in the running rail 5 as well. For example, a guide roller for the belt drive 17 can also be fastened engaging into the guide track 11. Likewise, a stop 51 for the door guide 10 can be inserted into the guide track 11 and be fastened by being clamped between the guide track 11 and the wall 23.

The guidance system 1 of the present invention further has the advantage that the drive system 13 or the drive device 15 and/or the operating panel 35 can be displaced in the longitudinal direction of the running rail 5, and that adaptations can thus be made during assembly. Further, a particularly compact design of the guidance system 1 of the present invention is possible. Moreover, due to the use of already existing means, such as the guide track 11, for example, a very simple structure of the guidance system 1 of the present invention has been realized.

1-12. (canceled)

13. A guidance system for sliding doors, with a running rail for guiding a track roller of a door guide, comprising:
a drive system having a drive device, and a travel space of the door guide extending in the longitudinal direction of the running rail, the travel space being delimited at least in part by the running rail, wherein the drive device is arranged in the longitudinal direction of the running rail as a prolongation of the travel space and is mounted via a mounting device in the running rail.

14. The guidance system of claim 13, wherein the running rail comprises a guide track for the track roller of the door guide, the mounting device engaging into the guide track of the running rail.

15. The guidance system of claim 14, wherein the running rail has a wall opposite the guide track, the mounting device clampingly engaging between the wall and the guide track.

16. The guidance system of claim 13, wherein a cover is fastened to the running rail, a cavity being formed between the cover and the running rail, in which cavity the drive system is arranged, the travel space being located in the cavity.

17. The guidance system of claim 16, wherein the cover visually conceals the drive device in a direction orthogonal to a major surface of the cover.

18. The guidance system of claim 13, wherein the drive system comprises a belt drive for driving a sliding door.

19. The guidance system of claim 13, wherein a cover is fastened to the running rail, a passage for the sliding door being formed between the cover and the running rail, with an operating panel for the drive system being arranged at or in the passage.

20. The guidance system of claim 19, wherein the operating panel is operable from a bottom side of the running rail.

21. The guidance system of claim 19, wherein the operating panel fits flush with the running rail and the cover.

22. The guidance system of claim 19, wherein the running rail has a first groove and the cover has a second groove arranged opposite the first groove, the operating panel engaging into the first and second grooves.

23. The guidance system of claim 22, wherein the first groove is formed in a first front face of the running rail and the second groove is formed in a second front face of the cover, the first and second front faces delimiting the passage.

24. The guidance system of claim 23, wherein the first front face adjoins the guide track.
